(19) United States
(12) Patent Application Publication
(10) Pub. No.: US 2014/0151931 A1
(43) Pub. Date: Jun. 5, 2014

(54) INJECTION MOLDING METHOD

(71) Applicant: The Procter & Gamble Company, Cincinnati, OH (US)

(72) Inventors: Gene Michael ALTONEN, West Chester, OH (US); John Moncrief LAYMAN, Liberty Township, OH (US); David Andrew DALTON, Mason, OH (US); Kevin HEDSPETH, Ashboro, NC (US)

(73) Assignee: The Procter & Gamble Company, Cincinnati, OH (US)

(21) Appl. No.: 14/174,374

(22) Filed: Feb. 6, 2014

Related U.S. Application Data
(63) Continuation of application No. 13/161,532, filed on Jun. 16, 2011.
(60) Provisional application No. 61/357,646, filed on Jun. 23, 2010.

(51) Int. Cl. B29C 45/00

(52) U.S. Cl. CPC B29C 45/0046
USPC 264/328.1

(57) ABSTRACT

A process for forming a product by injection molding.

### FIELD OF INVENTION

The present invention relates to systems and methods for injection molding and, more particularly, to systems and methods for high velocity injection molding and parts produced there from.

### BACKGROUND OF THE INVENTION

Injection molding is a technology commonly used for high-volume manufacturing of parts made of meltable material, most commonly of parts made of plastic. During a repetitive injection molding process, a plastic resin, most often in the form of small beads, is introduced to a injection molding machine that melts the resin beads under heat and pressure. The now molten resin is forcefully injected into a mold cavity having a particular cavity shape. The injected plastic is held under pressure in the mold cavity, cooled, and then removed as a solidified part having a shape that essentially duplicates the cavity shape of the mold. The mold itself may have a single cavity or multiple cavities. Each cavity may be connected to a flow channel by a gate, which directs the flow of the molten resin into the cavity. Thus, a typical injection molding procedure comprises four basic operations: (1) heating the plastic in the injection molding machine to allow it to flow under pressure; (2) injecting the melted plastic into a mold cavity or cavities defined between two mold halves that have been closed; (3) allowing the plastic to cool and harden in the cavity or cavities while under pressure; and (4) opening the mold halves to cause the part to be ejected from the mold.

The molten plastic resin is injected into the mold cavity and the plastic resin is forcibly pushed through the cavity by the injection molding machine until the plastic resin reaches the location in the cavity furthest from the gate. The resulting length and wall thickness of the part is a result of the shape of the mold cavity.

In some instances, there may be a desire among plastic manufacturers to reduce wall thicknesses of injection molded parts. Accordingly, a need exists for systems and methods for injection molding that provides parts having a thin wall thickness with adequate rigidity.

### SUMMARY OF THE INVENTION

In one embodiment, a product may comprise a body portion formed of a polymer-based resin, the body portion comprises a gate position, a last fill position, a flow length to wall thickness ratio greater than or equal to about 200, wherein the flow length is measured from the gate position to the last fill position, and a wall thickness less than or equal to about 1 millimeter, wherein the polymer-based resin has a melt flow index less than or equal to about 1000 grams/10 minutes. The product can be consumer goods packaging. The product can be formed by high velocity injection molding.

In one embodiment, a product may include a body portion formed of a polymer-based resin, wherein upon being formed by the high velocity injection molding process, the body portion may include a gate position, a last fill position, a flow length to wall thickness ratio greater than or equal to about 300, wherein the flow length is measured from the gate position to the last fill position, and a wall thickness that is substantially constant along the flow length and less than or equal to about 0.5 millimeter. The polymer-based resin may have a melt flow index less than or equal to about 50 grams/10 minutes. The product can be consumer goods packaging. The product can be formed by high velocity injection molding.

In another embodiment, a method for forming a product may include using a mold assembly having a cavity that produces an article by a high velocity injection molding process, introducing a polymer-based resin into the mold assembly by a high velocity injection molding process thereby forming the product, which may include a gate position, a last fill position, a flow length measured from the gate position to the last fill position, wall thickness that is substantially constant and less than or equal to about 0.5 millimeter, and a flow length to wall thickness ratio greater than or equal to about 200. The polymer-based resin may be introduced into the cavity at an average rate greater than or equal to about 300 cubic centimeters per second as measured at the gate position. The product can be consumer goods packaging.

In yet another embodiment, a product that is a preform that is formed by high velocity injection molding may include a tubular body having an open end, a dispensing end, and a wall portion, the wall portion may have a wall thickness that is less than or equal to about 0.5 millimeter, a gate position located on the dispensing end of the tubular body, a last fill position located on the open end of the tubular body, a flow length measured from the gate position to the last fill position, and a flow length to wall thickness ratio greater than or equal to about 300. The polymer-based resin forming the tubular body may have has a melt flow index less than or equal to about 800 grams/10 minutes. The product can be preform for consumer goods packaging.

In yet another embodiment, a product may include a body portion formed of a polymer-based resin. The body portion may include a gate position, a last fill position, a flow length to wall thickness ratio greater than or equal to about 200, wherein the flow length is measured from the gate position to the last fill position, and a wall thickness that is substantially constant along the flow length and less than or equal to about 0.375 millimeter. The polymer-based resin may have a melt flow index less than or equal to about 50 grams/10 minutes. The product can be consumer goods packaging. The product can be formed by high velocity injection molding.

In yet another embodiment, a product may include a tubular body having an open end, a dispensing end, and a wall portion, the wall portion may have a wall thickness that is less than or equal to about 0.375 millimeter, a gate position located on the dispensing end of the tubular body, a last fill position located on the open end of the tubular body, a flow length measured from the gate position to the last fill position, and a flow length to wall thickness ratio that may be greater than or equal to about 250. A polymer-based resin forming the tubular body may have a melt flow index less than or equal to about 800 grams/10 minutes. The product can be a preform for consumer goods packaging. The product can be formed by high velocity injection molding.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 illustrates a diagrammatic front view of a high velocity injection molding machine according to one or more embodiments shown and described herein.

FIG. 2 illustrates a perspective front view of a product according to one or more embodiments shown and described herein.

FIG. 3 illustrates a sectional front view along lines 3-3 of the product of FIG. 2 according to one or more embodiments shown and described herein.

FIG. 4 illustrates a perspective front view of a container according to one or more embodiments shown and described herein.

FIG. 5 illustrates a sectional front view of a preform according to one or more embodiments shown and described herein.

FIG. 6 illustrates a partial sectional view of a preform according to one or more embodiments shown and described herein.

FIG. 7 illustrates a sectional front view of a preform according to one or more embodiments shown and described herein.

FIG. 8 illustrates a sectional front view of a preform according to one or more embodiments shown and described herein.

FIG. 9 illustrates a sectional front view of a preform according to one or more embodiments shown and described herein.

FIG. 10 illustrates a perspective top view of a container product according to one or more embodiments shown and described herein.

FIG. 11 illustrates a sectional end view of a container product according to one or more embodiments shown and described herein.

FIG. 12 illustrates a front view of a product according to one or more embodiments shown and described herein.

FIG. 13 illustrates a perspective top view of a toothbrush according to one or more embodiments shown and described herein.

FIG. 14 illustrates a detailed perspective top view of the toothbrush of FIG. 13 according to one or more embodiments shown and described herein.

FIG. 15 illustrates a sectional front view of a tampon applicator according to one or more embodiments shown and described herein.

### DETAILED DESCRIPTION OF THE INVENTION

Embodiments of the present invention generally relate to systems, products, and methods of producing products by high velocity injection molding.

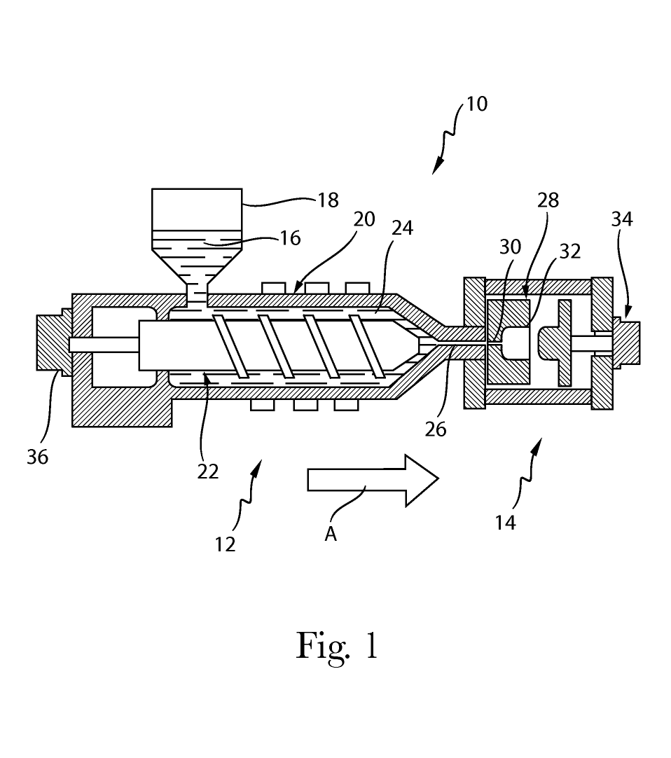

Referring to the figures in detail, FIG. 1 illustrates an exemplary injection molding machine 10 for producing thin-walled parts by high velocity injection molding. The injection molding machine 10 generally includes an injection system 12 and a clamping system 14. A polymer-based resin may be introduced to the injection system 12 in the form of resin pellets 16. The resin pellets 16 may be placed into a hopper 18, which feeds the resin pellets 16 into a heated barrel 20 of the injection system 12. The resin pellets 16, after being fed into the heated barrel 20, may be driven to the end of the heated barrel 20 by a reciprocating screw 22. The heating of the heated barrel 20 and the compression of the resin pellets 16 by the reciprocating screw 22 causes the resin pellets 16 to melt.

With the plastic now a molten resin 24, the reciprocating screw 22 is able to travel forward as indicated by arrow A in FIG. 1, and the reciprocating screw 22 can force the molten resin 24 through a nozzle 26 and into the clamping system 14. The molten resin 24 may be injected into a mold 28 through a gate 30, which directs the flow of the molten resin 24 to a mold cavity 32 that is formed in mating bodies of the mold 28 where the mold 28 is held together under pressure by a press 34. Once the pre-determined amount of molten resin 24 is injected into the mold, the reciprocating screw 22 stops traveling forward. The molten resin 24 takes the form of the mold cavity 32 and the molten resin 24 is allowed to cool inside the mold 28 until it solidifies. Once the molten resin 24 has solidified, the press 34 releases its force on the mating bodies of the mold 28, the mating bodies of the mold 28 may be separated from one another, and the finished part may be ejected, whereupon the process can repeat itself.

Without wishing to be bound by theory, there may be a desire among injection molded plastic manufacturers to reduce the wall thickness of injection molded parts as a means of reducing the plastic content, and thus cost, of the final part. This may be particularly true for consumer goods packaging products, where conventional injection molding manufacturing processes typically produce a part whose strength exceeds the requirements.

As used herein, wall thickness is average wall thickness of the entire part.

Reducing the wall thickness of an injection molded part using a conventional injection molding process, however, can be an expensive and non-trivial task, particularly when designing for wall thicknesses less than about 1.0 millimeter. As a liquid plastic resin is introduced into an injection mold in a conventional injection molding process, the material adjacent to the walls of the cavity immediately begins to “freeze,” or solidify and cure. As the material flows through the mold, a boundary layer of material is formed against the sides of the mold. As the mold continues to fill, the boundary layer continues to thicken, eventually closing off the path of material flow and preventing additional material from flowing into the mold. The plastic resin freezing on the walls of the mold is exacerbated when the molds are cooled, a technique used to reduce the cycle time of each part and increase machine throughput.

There may also be a desire to design a part and the corresponding mold such that the liquid plastic resin flows from areas having the thickest wall thickness towards areas having the thinnest wall thickness. Increasing thickness in certain regions of the mold can ensure that sufficient material flows into areas where strength and thickness is needed. This “thick-to-thin” flow path requirement can make for inefficient use of plastic and result in higher part cost for injection molded part manufacturers because additional material must be molded into parts at locations where the material is unnecessary.

One method to decrease the wall thickness of a part is to increase the pressure of the liquid plastic resin as it is introduced into the mold. By increasing the pressure, the molding machine can continue to force liquid material into the mold before the flow path has closed off. Increasing the pressure, however, has both cost and performance downsides. As the pressure required to mold the component increases, the molding equipment must be strong enough to withstand the additional pressure, which generally equates to being more expensive. A manufacturer may have to purchase new equipment to accommodate these increased pressures. Thus, a decrease in the wall thickness of a given part can result in significant capital expenses to accomplish the manufacturing via conventional injection molding techniques.

Additionally, when the liquid plastic material flows into the injection mold and freezes, the polymer chains retain the high levels of stress that were present when the polymer was in liquid form. These “molded-in” stresses can lead to parts that warp following molding, have reduced mechanical properties, and have reduced resistance to chemical exposure. The reduced mechanical properties are particularly important to control and/or minimize for injection molded parts such as thinwall tubs, living hinge parts, and closures.

A second technique to manufacture a component with a thinner wall thickness using a conventional injection molding technique is to use a material having a higher Melt Flow Index (MFI). MFI is a measure of a plastic resin's viscosity while it is liquid. A method for measuring MFI is disclosed in ASTM D1238. While the use of high MFI materials allows a part having a thinner wall thickness to be molded, these materials are generally less stiff than materials having a low or medium MFIs. Thus the resulting part often lacks the stiffness properties required for the application. For example, a “pusher” used to expel a tampon from a plastic applicator may not be stiff enough to apply sufficient force to the tampon before buckling. Similarly, plastic containers made from a material having a high MFI may not resist compression when stacked in a warehouse for extended periods of time.

It has been discovered that high velocity injection molding can be used to produce products having thin wall thicknesses (e.g., 0.75 millimeter or less) using plastic resins having a low MFI under relatively low cavity pressures. This can be accomplished by injecting the plastic resin having a relatively low MFI of no greater than about 1000 grams/10 minutes at relatively high average velocities of at least about 200 cubic centimeters per second (e.g., from about 200 cubic centimeters per second to about 900 cubic centimeters per second) at relatively low cavity pressures of at most about 69 MPa (e.g., from about 34.5 MPa to about 69 MPa). More particularly, the MFI would be no greater than about 800 grams/10 minutes, such as being no greater than about 600 grams/10 minutes, such as being no greater than about 400 grams/10 minutes, such as being no greater than about 200 grams/10 minutes, such as about 50 grams/10 minutes or less. Cavity pressure can be measured by installing a pressure tap or a transducer in a location that measures the pressure of the polymer-based resin inside the cavity during the injection process.

It has also been discovered that high velocity injection molding can be used to produce products having even thinner wall thicknesses (e.g., 0.5 millimeter or less) using plastic resins having a low MFI under relatively low cavity pressures. This can be accomplished by injecting the plastic resin having a relatively low MFI of no greater than about 1000 grams/10 minutes at relatively high average velocities of at least about 200 cubic centimeters per second (e.g., from about 200 cubic centimeters per second to about 900 cubic centimeters per second) at relatively low cavity pressures of at most about 137.9 MPa (e.g., from about 34.5 MPa to about 137.9 MPa). More particularly, the MFI would be no greater than about 800 grams/10 minutes, such as being no greater than about 600 grams/10 minutes, such as being no greater than about 400 grams/10 minutes, such as being no greater than about 200 grams/10 minutes, such as about 50 grams/10 minutes or less.

It has also been discovered that high velocity injection molding can be used to produce products having even thinner wall thicknesses (e.g., 0.375 millimeter or less) using plastic resins having a low MFI under relatively low cavity pressures. This can be accomplished by injecting the plastic resin having a relatively low MFI of no greater than about 1000 grams/10 minutes at relatively high average velocities of at least about 200 cubic centimeters per second (e.g., from about 200 cubic centimeters per second to about 900 cubic centimeters per second) at relatively low cavity pressures of at most about 137.9 MPa (e.g., from about 34.5 MPa to about 137.9 MPa). More particularly, the MFI would be no greater than about 800 grams/10 minutes, such as being no greater than about 600 grams/10 minutes, such as being no greater than about 400 grams/10 minutes, such as being no greater than about 200 grams/10 minutes, such as about 50 grams/10 minutes or less.

It has also been discovered that high velocity injection molding can be used to produce products having even thinner wall thicknesses (e.g., 0.25 millimeter or less) using plastic resin having a relatively low MFI under relatively low cavity pressures. This can be accomplished by injecting the plastic resin having a relatively low MFI of no greater than about 1000 grams/10 minutes at relatively high average velocities of at least about 200 cubic centimeters per second or higher (e.g., from about 200 cubic centimeters per second to about 900 cubic centimeters per second) at relatively low cavity pressures of at most about 172.4 MPa (e.g., from about 34.5 MPa to about 172.4 MPa). More particularly, the MFI would be no greater than about 800 grams/10 minutes, such as being no greater than about 600 grams/10 minutes, such as being no greater than about 400 grams/10 minutes, such as being no greater than about 200 grams/10 minutes, such as about 50 grams/10 minutes or less.

Illustrative machines that are capable of performing the high velocity injection molding process include the Husky HyPAC series of reciprocating-screw injection machines. This type of machine uses a ram 36 that can inject molten resin 24 at a high velocity over a short duration. For example, this type of machine is able to inject about 40 grams of molten resin 24 into a thinwall mold in about 0.05 second, whereas a conventional injection molding machine injects about the same quantity of resin into the same mold at about the same resin temperature in about 0.5 second. The high velocity injection molding process uses a “single stage” injection molding system, whereby the reciprocating screw 22 mixes and melts the resin pellets 16 and forces the molten resin 24 through the nozzle 26 and into the mold 28. This differs from a “two stage” injection molding system (not shown) whereby the screw only mixes and melts the resin pellets. In such a “two-stage” system, the molten resin 24 is held in a “shot pot” for injection at a later time by a separate injection rod. One skilled in the art would recognize that a two-stage system could be fitted to achieve these high injection rates, such as the Husky HyPAC series of two-stage injection machines.

A variety of polymers can be used in the high velocity injection molding process. This includes polymers classified as thermoplastics, thermosets, and elastomers. The polymers can be selected from the group consisting of thermoplastics, thermosets, elastomers, and combinations thereof. Of particular interest are thermoplastics classified as polyolefins because of their mechanical properties when cured and characteristic of shear thinning when in a molten state. Shear thinning, a reduction in viscosity when the fluid is placed under compressive stress, may be beneficial for molten resins in a pressurized injection molding process. This group of polyolefins includes thermoplastics such as polyethylene, polypropylene, polymethylpentene, and polybutene-1. The polymers can be selected from the group consisting of polyethylene, polypropylene, polymethylpentene, polybutene-1, and mixtures thereof. For example, a polyethylene material exhibits a MFI in the range from about 1 gram/10 minutes to about 24 grams/10 minutes when held in a molten state at about 240 degrees Celsius. This range of MFI is associated with high strength and stiffness in the solid state, which is desirable for finished part strength and durability. Additionally, blends of polymers or polymers with added non-polymer fillers can also be used in the high velocity injection molding process.

Thermoplastic polymers can be selected from the group consisting of acrylonitrile butadiene styrene (ABS), acrylic, celluloid, cellulose acetate, ethylene-vinyl acetate (EVA), ethylene vinyl alcohol (EVAL), fluoroplastics (PTFEs, including FEP, PFA, CTFE, ECTFE, ETFE), ionomers, acrylic-polyvinyl chloride alloy, liquid crystal polymer (LCP), polyacetal (POM or Acetal), polyacrylates (Acrylic), polyacrylonitrile (PAN or Acrylonitrile), polyamide (PA or Nylon), polyamide-imide (PAI), polyaryletherketone (PAEK or Ketone), polybutadiene (PBD), polybutylene (PB), polybutylene terephthalate (PBT), polyethylene terephthalate (PET), polycyclohexylene dimethylene terephthalate (PCT), polycarbonate (PC), polyhydroxyalkanoates (PHAs), polyketone (PK), polyester, polyethylene (PE) including low density (LDPE) and high density (HDPE) versions, polyetheretherketone (PEEK), polyetherimide (PEI), polyethersulfone (PES), polysulfone, polyethylenechlorinates (PEC), polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), polyvinyl chloride (PVC), polyvinylidene chloride (PVDC), spectralon, and combinations thereof. Any of the aforesaid may comprise bio derived (in part or whole) polymers or monomers that are then subject to polymerization. The polymer-based resin can be at least partially derived from a renewable resource. The polymer-based resin can be formed from a combination of monomers derived from renewable resources and monomers derived from a non-renewable resource.

One advantage of the high velocity injection molding process is that the molten resin 24 undergoes significant polymer compression during the injection process. The molten resin 24 has been measured to compress from about 4% to about 12%, depending on the composition of the resin. The molten resin 24 is compressed by the reciprocating screw 22 before being injected through the nozzle 26 into the mold 28. The molten resin 24 is compressed to near the compressive capacity of the material itself. Each material has its own characteristic compressibility capacity that varies depending on the pressure, volume, and temperature that the molten resin is subject to, and can be determined by a person of ordinary skill in the art through the use of a dilatometer. Subsequent to the injection process itself, the molten resin 24 may relax throughout the entire system, including any material in the mold cavity 32, the gate 30, the nozzle 26, and ahead of the reciprocating screw 22. The relaxation of the molten resin 24 may allow energy stored in the compressed molten resin 24 to release as heat which may further lower the molten resin's 24 in situ viscosity and may further assist with filling a mold cavity's 32 thin channels.

Additionally, the relaxation of the molten resin 24 may allow at least one embodiment of the high velocity injection molding process and/or system to produce parts that have a high and uniform pack density and more uniform dimensions than a conventional molding process. Those skilled in the art will recognize the need for uniform pack density throughout the mold cavity 32. Parts having low pack density are subject to sink, or shrinkage of the solidified material away from the walls of the mold cavity 32. Sink exhibits itself as dimensional irregularity in the finished part and is typically seen in parts processed in conventional molding processes at locations far from the gate position 42, and is particularly evident in parts having high flow length to wall thickness ratios. It may be difficult through conventional molding processes to evenly distribute material through a thinwalled mold cavity 32. Because the high velocity injection molding process injects molten resin 24 into the mold 28 in a compressed state and the molten resin decompresses inside the mold cavity 32, the molten resin 24 may be of more uniform pack density than if it were injected in a conventional molding process. Further, this uniform pack density may result in a lack of sink in parts, which may result in parts that conform closer to the shape of the mold cavity 32 than parts made in a conventional molding process.

Further, at least one embodiment of the high velocity injection molding process and/or system may allow for filling thinwalled mold cavities 32 without the use of blowing agents. As known by those skilled in the art, blowing agents can be used to reduce the viscosity of the molten resin 24, which is equivalent to using a polymer-based resin with a higher MFI. The use of blowing agents, however, may result in lower part density and a poor surface finish. Parts made by at least one embodiment of the high velocity injection molding process and/or system may not exhibit these characteristics. The high velocity injection molding process may result in a part density that is within about 3% of an inherent density of the polymer-based resin, such as a part density that is within about 2% of an inherent density of the polymer-based resin, such as a part density that is within about 1% of an inherent density of the polymer-based resin, such as a part density that is within about 0.5% of an inherent density of the polymer-based resin. As used herein, inherent density refers to the density of the polymer-based resin when supplied in a solid, pre-processed form, i.e., prior to being heated in the high velocity injection molding process; for example resin pellets 16.

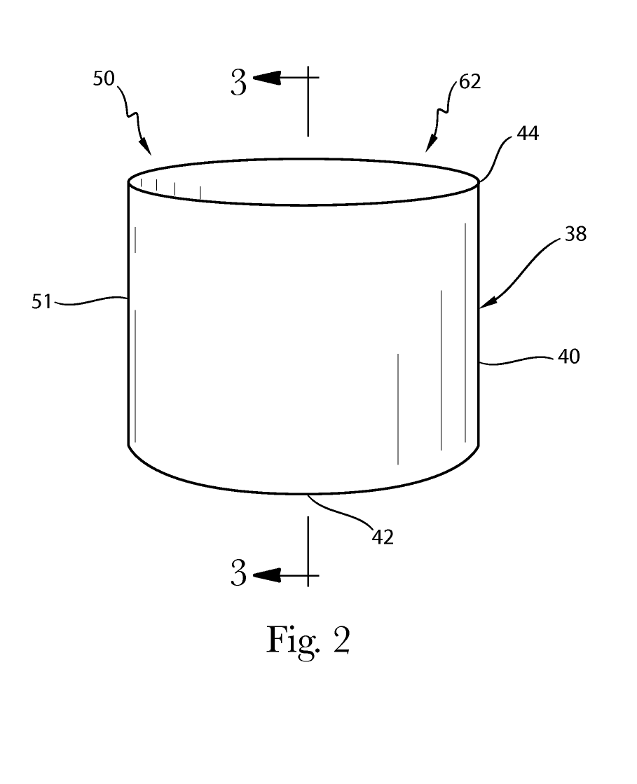

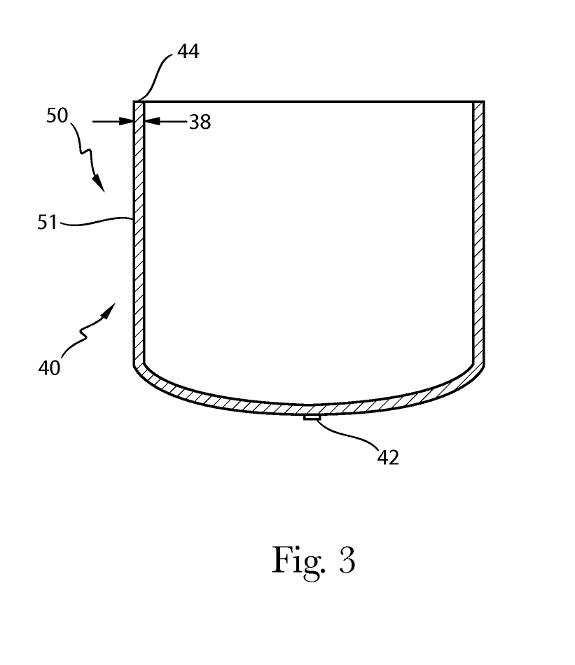

The use of these materials in the high velocity injection molding process allows for the manufacture of parts that have thin wall thicknesses 38 and long flow lengths 40, as shown in FIGS. 2 and 3. The flow length 40 of a part may be measured along the shortest path of material flow from the gate position 42 to the last fill position 44 of the part. The wall thickness may be substantially constant along the flow length. The gate position 42 corresponds to the location of the gate 30 relative to the mold cavity 32 (FIG. 1). The last fill position 44 of the part corresponds to the location in the mold cavity 32 (FIG. 1) that fills last. The wall thickness 38 corresponds to the gap between the walls of the mold cavity 32 (FIG. 1). Of interest are parts having wall thicknesses less than about 1 millimeter, such as less than about 0.75 millimeter, such as less than about 0.5 millimeter, such as less than about 0.4 millimeter, such as less than about 0.3 millimeter, such as less than about 0.25 millimeter. The high velocity injection molding process allows for the manufacture of parts using a resin having a MFI of less than about 50 grams/10 minutes where the parts have flow length 40 to wall thickness 38 ratios of about 450 with wall thicknesses of less than about 1.0 millimeter, such as ratios from about 450 to about 1500; ratios in excess of about 350 with wall thicknesses of less than about 0.75 millimeter, such as ratios from about 350 to about 1250; ratios in excess of about 200 with wall thicknesses of less than about 0.5 millimeter, such as ratios from about 300 to about 1000; ratios in excess of about 200 with wall thicknesses of less than about 1 millimeter, such as ratios from about 300 to about 1000; ratios in excess of about 200 with wall thicknesses of less than about 0.375 millimeter, such as ratios from about 250 to about 750; and ratios in excess of about 150 with wall thicknesses of less than about 0.25 millimeter, such as ratios from about 150 to about 500. The ability to reduce wall thickness 38 while maintaining a long flow length 40 allows designers to minimize the plastic content per part, which can further reduce part cost. The flow length 40 to wall thickness 38 ratio can be greater than or equal to about 500.

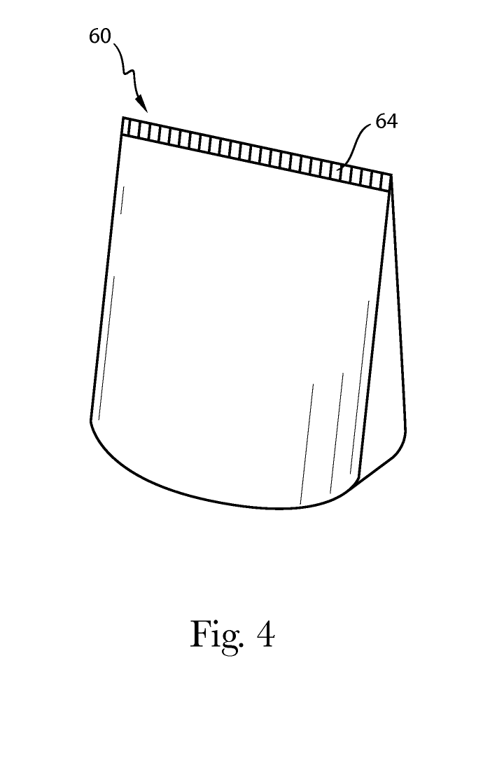

An example of a product 50 produced by the high velocity injection molding process is shown in FIGS. 2 and 3. The product 50 could be used as a package for storage and transport of a number of consumer goods. The product 50 has body portion 51 that has a nominal wall thickness 38 of about 0.5 millimeters or less, which allows for sufficient resilience to any pressure that is applied during normal use. The flow length 40, measured along the shortest path of material flow from the gate position 42 to the last fill position 44, is approximately 170 millimeters, giving a flow length to wall thickness ratio of about 340. As depicted in FIG. 2, the end opposite the gate position is open when the product 50 is removed from the injection molding machine 10. In order to form a container 60 as depicted in FIG. 4, this open end 62 must be sealed. Typically, the open end 62 would be flattened locally and welded onto itself such that a weld joint 64 is formed. The product 50 can be a package. The product 50 can be a consumer goods packaging product. The product 50 can be a product having a label provided by in-mold labeling.

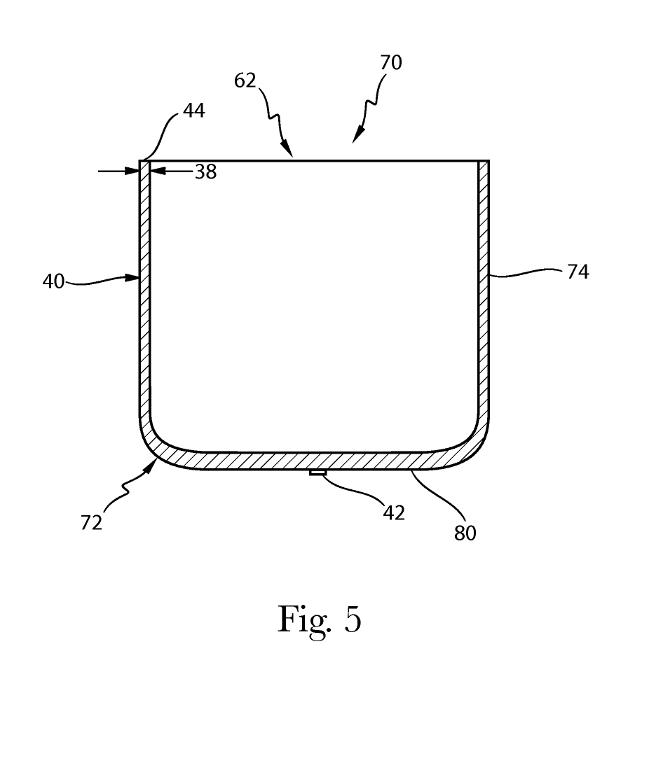

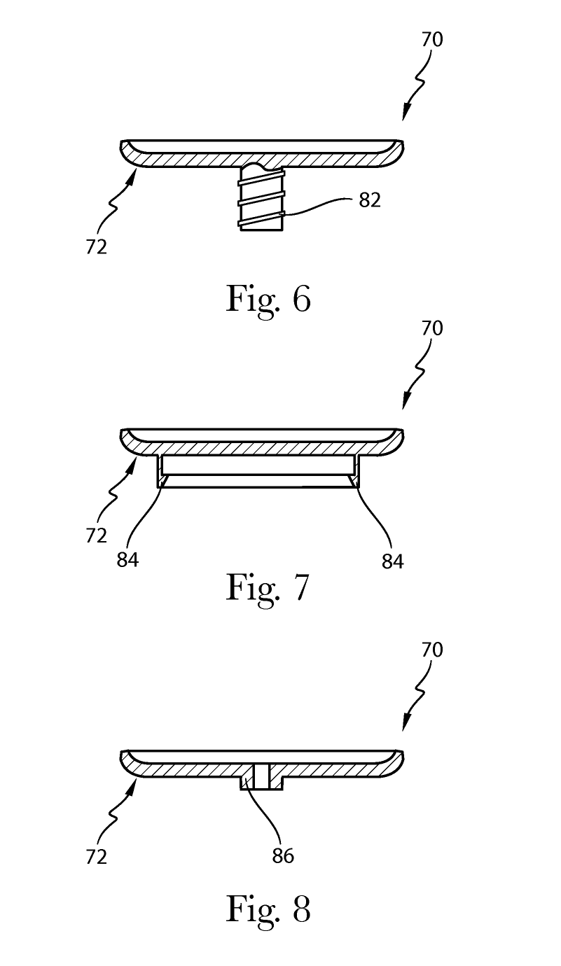

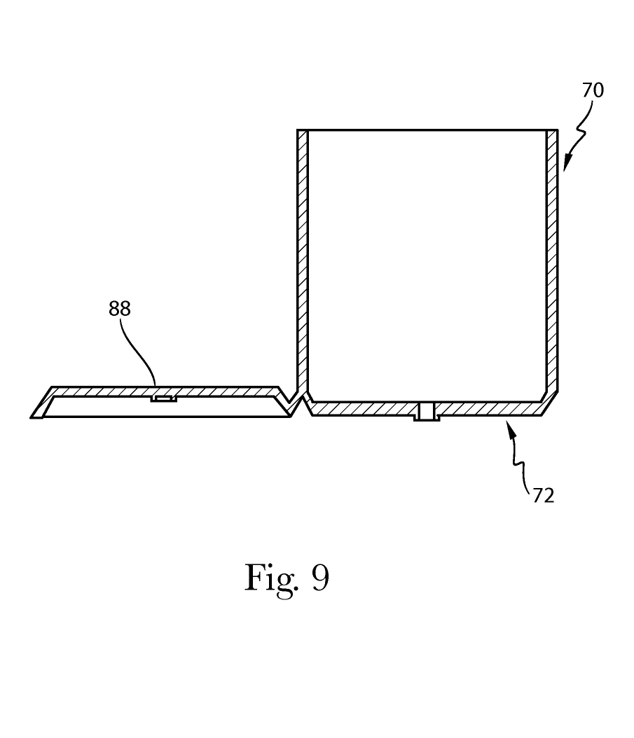

Further improvements on a product can be realized. As depicted in FIG. 5, a preform 70 can be manufactured having a dispensing end 72 and a tubular body 74, where the gate position 42 is located on the dispensing end 72 of the preform 70 and the last fill position 44 is located on the open end 62 of the tubular body 74. As used herein, preform refers to an object that has at least been subject to preliminary molding and may be subject to further processing or assembly. The wall thickness 38 is about 0.5 millimeter and the flow length 40 to wall thickness 38 ratio is about 340. As shown in FIG. 5, the thickness of the dispensing end 72 can be significantly thicker than the wall thickness 38 of the tubular body. The ability to mold additional thickness can be used to create a base feature 80 to rest the preform on while not in use or as a location to mold retaining features, such as screw threads 82 or tabs 84, as shown in FIGS. 6 and 7, respectively. Further, the additional thickness allows for the formation of an integral nozzle 86 located on the dispensing end 72 to allow a user to direct the flow of the consumer good, as shown in FIG. 8. As shown in FIG. 9, the preform 70 could be molded such that the dispensing end 72 comprises an integral movable cap 88 which can selectively be opened or closed to allow or prevent the expelling of the consumer good from the container.

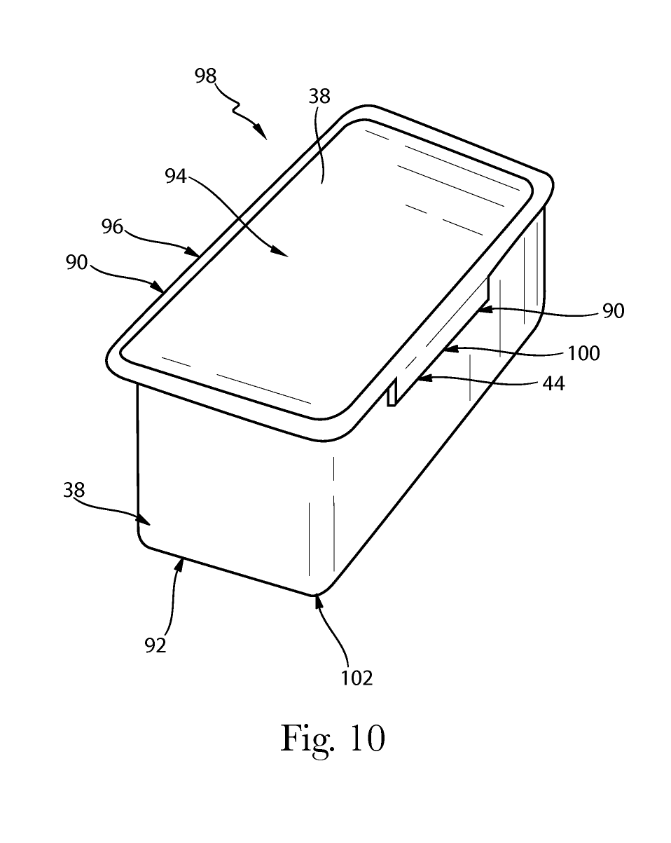

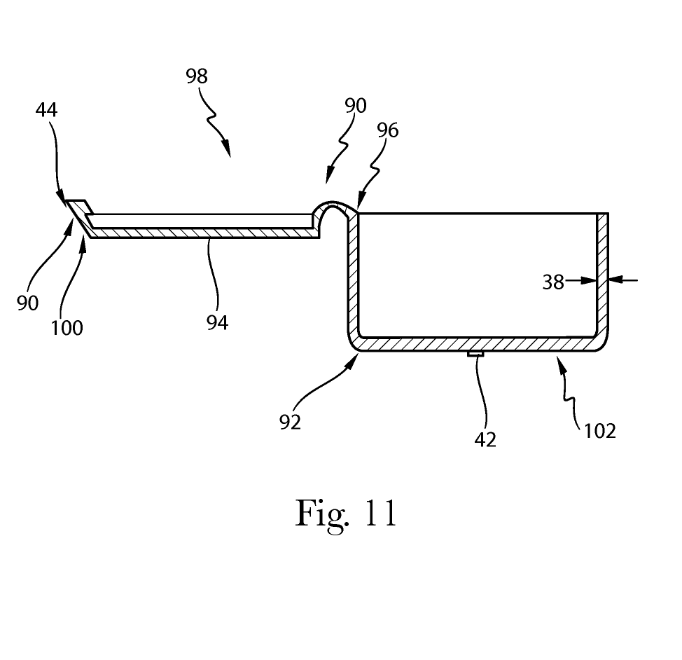

The high velocity injection molding process also allows for the creation of parts by injection molding a part having a gate position 42 in an area having a thin wall thickness 38 and a last fill position 44 on an area having a thick wall thickness 90. As shown in FIGS. 10 and 11, a container product 98 having generally thin wall thicknesses 38 through the body 92 and the top 94 has thick wall thicknesses 90 in the hinge location 96 and the latch 100. The high velocity injection molding process allows the designer to place the gate position 42 on the bottom 102 of the container product 98 to minimize mold fill time while maintaining the ability to fully fill the mold cavity 32 in areas having a thicker wall thickness 90 than at the gate position 42.

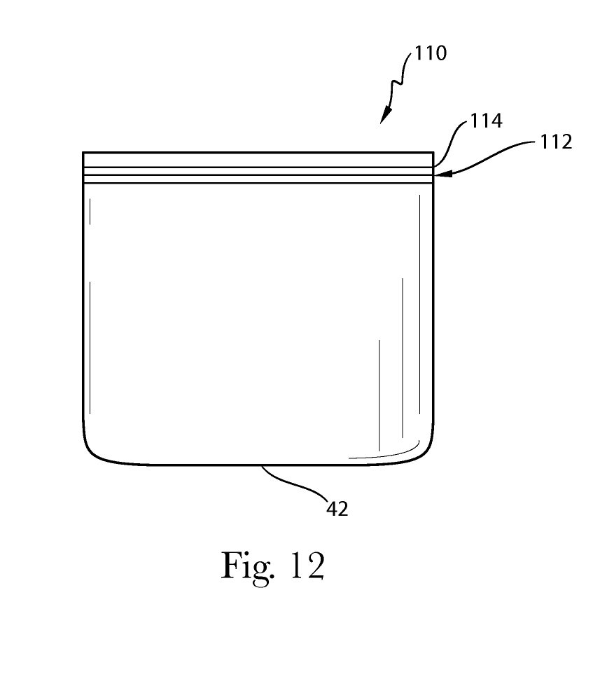

As shown in FIG. 12, a packaging product 110 having a integrally-formed zippered lock 112 can be formed by the high velocity injection molding process. The high velocity injection molding process allows the molten resin 24 to be injected near the bottom of the packaging product 110, forming a gate position 42, from which the molten resin 24 then flows towards the area of the zippered lock 112, where more thickness is required to form the locking features 114.

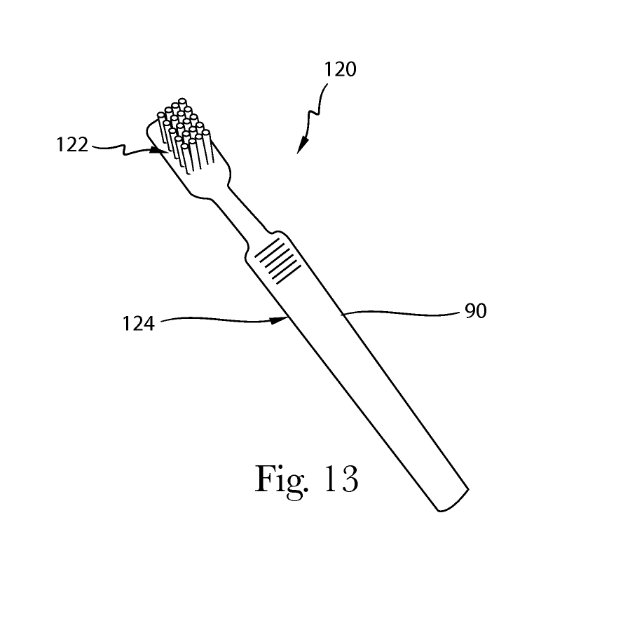

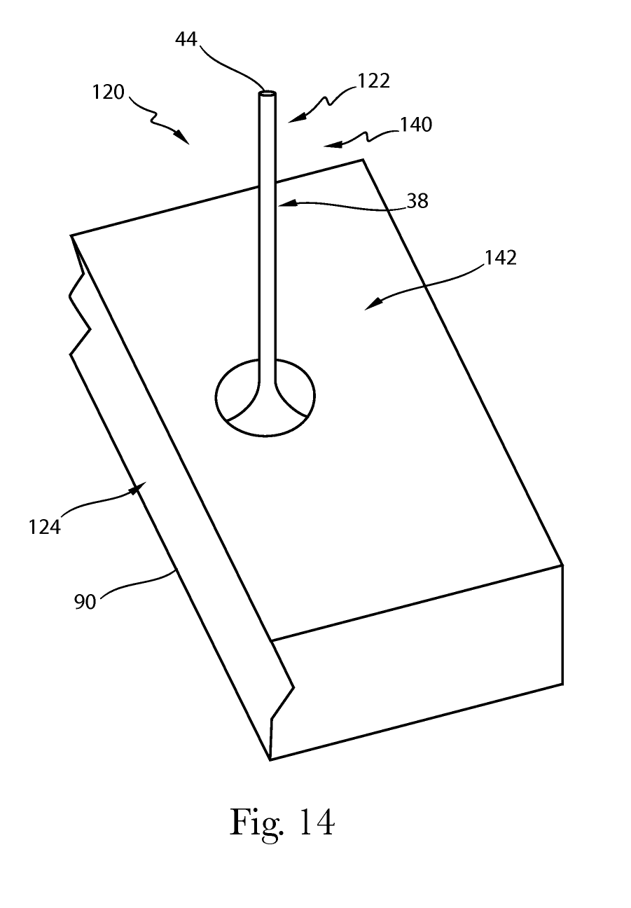

It is believed that a full range of products can be formed from the high speed injection molding process. For example, as shown in FIGS. 13 and 14, a toothbrush 120 having integrally-formed bristles 122 can be formed in a single step. Because material may flow primarily along the toothbrush handle 124 having a thick wall thickness 90, it is beneficial to identify an effective flow length 140 of the bristles 122 that is measured from the bristle bed 142 to the point of last fill 44. The high speed injection molding process allows for the formation of long, slim members such as bristles 122, having a thin wall thickness 38 and where the effective flow length to wall thickness ratio is large, in the same step as the toothbrush handle 124, having a thick wall thickness 90 and where the flow length to wall thickness is low. Thus, in a single operation, an integral product (i.e., the toothbrush 120) can be produced using a single polymer-based resin that has local regions of high strength (i.e., the toothbrush handle 124) and local regions of high flexibility (i.e., the bristles 122). Further, formation of the toothbrush handle 124 and bristles 122 in a single step allows the manufacturer to eliminate the steps of bristle formation, bundling, and attachment.

Applicators or implements having integrally-formed bristles, filaments, surface flocking, or other thin protrusions can be formed from this high velocity injection molding process for use with a range of cosmetic or personal care compositions and product forms. Non-limiting examples of compositions may include mascara, eyeliner, eyeshadow, lip color, lip gloss, foundation, concealer, blush, nail polish, lotion, moisturizer, exfoliation product, anti-aging product, body wash, and facial cleanser. Non-limiting examples of product forms may include low viscosity liquids, high viscosity creams or pastes, and pressed or loose powders. For example, molded mascara brushes or applicators have recently become popular, in part due to their superior performance versus twisted wire brush mascara applicators. Molded brushes can have the advantage of having their bristles, or protrusions, formed in such a way that some or all of them terminate at the core at unique, predetermined points. In molded applicators, the desired distance between adjacent protrusions can be maintained along the length of the protrusions, and the size, shape, and relative positioning of the protrusions can be beneficially established to create a better deposition of the mascara and coverage of the lashes, as well as to achieve a superior combing and separation of the lashes. As defined herein, a protrusion is a surface extension that protrudes or extends outwardly from the core, handle, or main body of the cosmetic applicator or implement. Core means the part of the applicator's body upon which the protrusions are located. In the case of mascara applicators, the core is attached to a stem. By attached it is meant that the core is either physically affixed, or joined, to the stem, or that the core and the stem are built as an integral unit. Stem means a part or parts of the applicator's body that can be attached to (i.e., affixed to or made integral with) the core at one of its ends. At the stem's other end, the stem can be attached to (i.e., affixed to or made integral with) a handle or a closure/lid from a corresponding product container.

In addition, the high velocity injection molding process can allow for the formation of thick-wall product containers (e.g., a mascara or eyeliner bottle/tube) having an integrally-formed thin-wall wiping or scraping member. For example, a thin, flexible and resilient annular wiper member for removing excess mascara or eyeliner fluid from an applicator when withdrawn from its container can be integrally-formed into the container neck or opening orifice of a thick-wall mascara or eyeliner bottle. Thus, this molding process allows for a simpler manufacturing process wherein the need for forming a separate wiper piece and then inserting the separate wiper piece into the product container is eliminated.

The product can be a blister pack or clam-shell for product packaging. The blister pack or clam-shell can be translucent. The blister pack or clam-shell can be clear. The product can be a bottle shroud, bottle decoration, or gripping feature. The product can be a replaceable decoration part that can be associated and/or disassociated with another product. For example the product can be a mobile telephone cover that can be associated and disassociated with a mobile telephone.

The product can be a product in a category of goods including, but not limited to, antiperspirants, baby care, colognes, commercial products (including wholesale, industrial, and commercial market analogs to consumer-oriented consumer products), cosmetics, deodorants, dish care, feminine protection, hair care, hair color, health care, household cleaners, incontinence care, laundry, oral care, paper products, personal cleansing, disposable absorbent articles, pet health and nutrition, prescription drugs, prestige fragrances, skin care, snacks and beverages, special fabric care, shaving and other hair growth management products, small appliances, devices and batteries. A variety of product forms may fall within each of these product categories. Exemplary product forms and brands are described on The Procter & Gamble Company's website www.pg.com, and the linked sites found thereon. It is to be understood that products and consumer products that are part of product categories other than those listed above are also contemplated by the present invention, and that alternative product forms and brands other than those disclosed on the above-identified website are also encompassed by the present invention.

The product can be made from a variety of materials, can be made in numerous configurations, and can be made with any manufacturing techniques known to the skilled artisan. The product can be packaging, including, but not limited to, boxes, bags, pouches, paperboard cans, bottles, tottles, jars, thermoform blisters, clamshells, and combinations thereof. Other packaging embodiments are equally suitable.

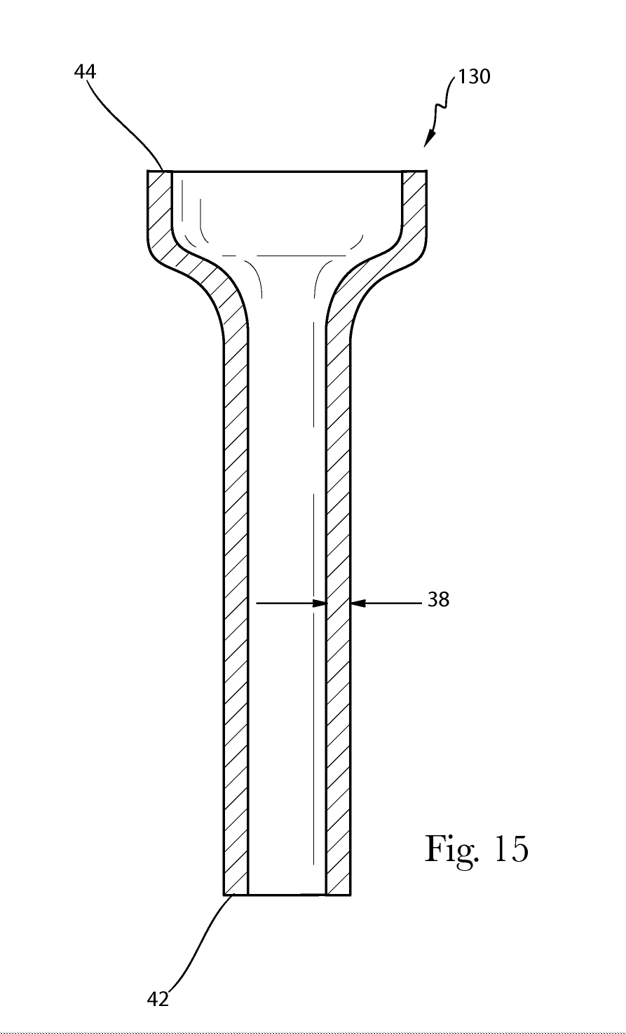

Additionally, the high velocity injection molding process allows for thinning the walls of currently manufacturer products. For example, as shown in FIG. 15, a tampon pusher 130 may have its wall thickness 38 thinned resulting in decreased plastic material usage per part. The high velocity injection molding process improves manufacturability of the part that has more material near the last fill position 44 than at the gate position 42 because of the increased part diameter at the last fill position 44.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

It should now be apparent that the various embodiments of the products illustrated and described herein may be produced by a high velocity injection molding process. While particular reference has been made herein to products for containing consumer goods or consumer goods products themselves, it should be apparent that the high velocity injection molding method discussed herein may be suitable for use in conjunction with products for use in the consumer goods industry, the food service industry, the transportation industry, the medical industry, the toy industry, and the like.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A process for forming a product, said process comprising the steps of:
injecting molten polymer-based resin having a melt flow index less than or equal to about 1000 grams/10 minutes into a mold having cavity at an average rate greater than or equal to about 300 cubic centimeters per second as measured at a gate position of said product to form said product, wherein when said polymer-based resin is introduced into said cavity said polymer-based resin is compressed to about a maximum compressive capacity of said polymer-based resin based on said polymer-based resin's pressure-volume-temperature properties and said polymer-based resin decompresses in a liquid state while inside said cavity, wherein said product has a part density within about 3% of an inherent density of said polymer-based resin;
wherein said product comprises:
a body portion formed of said polymer-based resin, said body portion comprises:
said gate position;
a last fill position;
a flow length to wall thickness ratio greater than or equal to about 200, wherein said flow length is measured from said gate position to said last fill position; and
a wall thickness less than or equal to about 1 millimeter.

2. The process according to claim 1, wherein a pressure of said polymer-based resin measured inside said cavity does not exceed about 137.9 MPa.

3. The process according to claim 1, wherein said polymer-based resin has a melt flow index less than or equal to about 400 grams/10 minutes.

4. The process according to claim 1, wherein said polymer-based resin is a shear thinning fluid.

5. The process according to claim 1, wherein said flow length to wall thickness ratio is greater than or equal to about 500.

6. The process according to claim 5, wherein said polymer-based resin is a shear thinning fluid.

7. A process for forming a product, said process comprising the steps of:
injecting molten polymer-based resin into a mold having cavity at an average rate greater than or equal to about 300 cubic centimeters per second as measured at a gate position of said product to form said product;
wherein said product comprises:
a body portion formed of a polymer-based resin, said body portion comprises:
said gate position;
a last fill position;
a flow length to wall thickness ratio greater than or equal to about 200, wherein said flow length is measured from said gate position to said last fill position; and
a wall thickness less than or equal to about 1 millimeter;
wherein said polymer-based resin has a melt flow index less than or equal to about 1000 grams/10 minutes.

8. The process according to claim 7, wherein when said polymer-based resin is introduced into said cavity said polymer-based resin is compressed to about a maximum compressive capacity of said polymer-based resin based on said polymer-based resin's pressure-volume-temperature properties and said polymer-based resin decompresses in a liquid state while inside said cavity.

9. The process according to claim 8, wherein a pressure of said polymer-based resin measured inside said cavity does not exceed about 137.9 MPa.

10. The process according to claim 7, wherein said polymer-based resin has a melt flow index less than or equal to about 400 grams/10 minutes.

11. The process according to claim 7, wherein said polymer-based resin is at least partially derived from a renewable resource.

12. The process according to claim 7, wherein said wall thickness is substantially constant along said flow length.

13. The process according to claim 7, wherein said wall thickness is less than or equal to about 0.5 millimeter.

14. The process according to claim 7, wherein said polymer-based resin has a melt flow index less than or equal to about 50 grams/10 minutes.

15. The process according to claim 7, wherein said flow length to wall thickness ratio is greater than or equal to about 500.

16. The process according to claim 7, wherein said polymer-based resin comprises a thermoplastic polymer.

17. The process according to claim 16, wherein said thermoplastic polymer is a polyolefin.

18. The process according to claim 7, wherein said polymer-based resin is a shear thinning fluid.

19. The process according to claim 7, wherein said product has a part density within about 3% of an inherent density of said polymer-based resin.

20. The process according to claim 7, wherein said product is a preform, said preform comprising a tubular body having an open end and a dispensing end.
